(19) United States
(12) Patent Application Publication
(10) Pub. No.: US 2009/0278817 A1
(43) Pub. Date: Nov. 12, 2009

(54) Touch-Screen Apparatus and Image-Capturing System Thereof

(75) Inventor: Huei Chuan Tai, Hsinchu (TW)

Correspondence Address: Eschweiler & Associates LLC;National City Bank Building, 629 Euclid Avenue, Suite 1000, Cleveland, OH, 44114, US

(73) Assignee: Shanghai Microtek Technology Co., Ltd., Shanghai (CN)

(21) Appl. No.: 12/240,431

(22) Filed: Sep. 29, 2008

(30) Foreign Application Priority Data
May 8, 2008 (TW) 97117050

(51) Int. Cl. G06F 3/043

(52) U.S. Cl. 345/177

(57) ABSTRACT

A touch-screen apparatus provides input commands from touch or moving action of single point touch, multi points touch by a user for implement of image capture. The touch-screen apparatus is coupled with a control interface of image capture via wire or wireless method, which provides the user another selection to operate the process of image capture.

### BACKGROUND OF THE INVENTION

1. Field of the Invention

The present invention relates to a control apparatus applied to an image-capturing apparatus; and more particularly, relates to a touch-screen apparatus applied to the image-capturing apparatus.

2. Description of the Prior Art

Touch-screen apparatus is one of the most important input devices for modern electrical equipments. In general, there are various types of the touch-screen apparatus applied to various electrical equipments, such as capacitance type, IR type, resistance type and ultrasound type, and so on.

### SUMMARY OF THE INVENTION

The present invention is directed to a touch-screen apparatus for users to instinctively operate the image-capturing apparatus.

The present invention is also directed to a touch-screen apparatus applied to an image scanner. The image scanner is equipped with the touch-screen apparatus as another input device.

Accordingly, one embodiment of the present invention provides a touch-screen apparatus coupled with the user interface of an image-capturing equipment. The touch-screen apparatus includes a detector detecting a touch motion and a display. When the user interface of the image-capturing equipment provides a plurality of items relevant to the image-capturing equipment, and the display displaying a plurality of patterns corresponding to the portion of items, the detector detects the touch motion on any of the patterns and transmits the touch motion to the user interface of the image-capturing equipment to be a control command for the corresponding item on the user interface. The touch-screen apparatus integrates an image-capturing equipment and a host to become an image-capturing system. The characteristics are in that the host provides and controls a user interface to communicate with the image-capturing equipment and the touch-screen apparatus, the user interface provides a plurality of items relevant to the image-capturing equipment. When the user interface of the image-capturing equipment provides a plurality of items relevant to the image-capturing equipment, and the display displaying a plurality of patterns corresponding to the portion of items, the detector detects the touch motion on any of the patterns and transmits the touch motion to the user interface of the image-capturing equipment to be a control command for the corresponding item on the user interface.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

FIG. 1 is a schematic diagram illustrating a touch-screen apparatus and the image-capturing equipment thereof in accordance with a first embodiment of the present invention.

FIG. 2A is a schematic diagram illustrating the display user interface of a display according to one embodiment of the present invention.

FIG. 2B is a schematic diagram illustrating the display of a touch-screen apparatus according to one embodiment of the present invention.

FIG. 3A is another schematic diagram illustrating the display of a touch-screen apparatus according to one embodiment of the present invention.

FIG. 3B is another schematic diagram illustrating the display of a touch-screen apparatus according to one embodiment of the present invention.

FIGS. 4A, 4B, and 4C are schematic diagrams illustrating the display of a touch-screen apparatus according to one embodiment of the present invention.

FIG. 5A and FIG. 5B are views illustrating the touch-screen apparatus according to one embodiment of the present invention.

### DETAILED DESCRIPTION OF THE INVENTION

The embodiments of the present invention are illustrated in reference to the drawings.

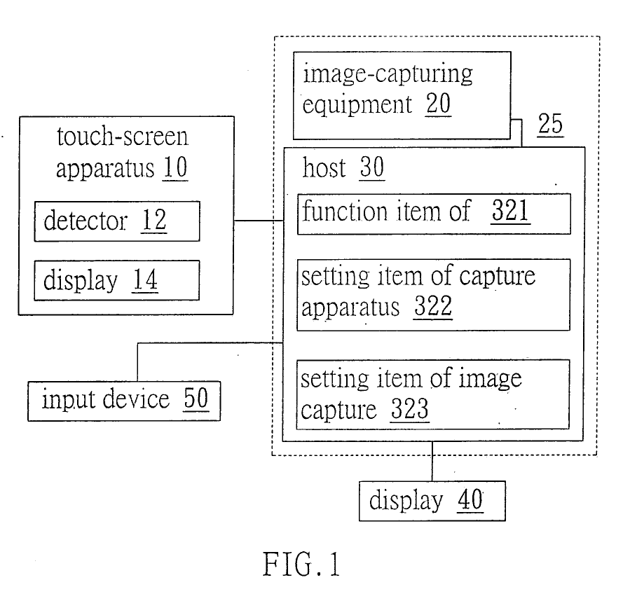

FIG. 1 is a schematic diagram illustrating a touch-screen apparatus and the image-capturing equipment thereof in accordance with a first embodiment of the present invention. A host 30 is electrically coupled to an image-capturing equipment 20, an input device 50, a display 40 and a touch-screen apparatus 10. In one embodiment, the host 30 is an electrical apparatus equipped with a processor, such as a desktop or a laptop, and is electrically coupled to the image-capturing equipment 20, the input device 50, the display 40 and the touch-screen apparatus 10 via wired or wireless collection. Next, the image-capturing equipment 20 may be an image scanner or apparatus with scanning function, such as multi function printer or fax machine. Alternatively, the image-capturing equipment 20 may be equipped with a built-in processor, and integrated with the host 30 to constitute an image-capturing system 25. Furthermore, the display 40 may be a liquid crystal display, plasma display or other apparatus with displaying function. The input device 50 may be, for example but not limited to, a wired or a wireless keyboard.

In the embodiment, the host 30 coordinates the image-capturing equipment 20, the input device 50, the display 40 and the touch-screen apparatus 10. Taking a desktop as an example, in addition to a typical operation system for the coordination of the input device 50 and the display 40, the host 30 is further equipped with a user interface for the communication of the image-capturing equipment 20 and the touch-screen apparatus 10. The user interface is implemented by a suitable application and displayed on the display 40, which provides a function item of capture apparatus 321, a setting item of capture apparatus 322 and a setting item of image capture 323 which may correspond to the image-capturing equipment 20 and the touch-screen apparatus 10.

The touch-screen apparatus 10 is electrically coupled to the host 30 via wired or wireless connection, which is equipped with a detector 12 and a display 14. The detector 12 is configured for detecting any direct or indirect motion or touching of any suitable tool or a user's fingers or toes on the touch-screen apparatus 10. The motion or touching includes an initial touch point, single point touch, multi-point touch, one-finger sliding, fingers sliding, click or double clicks. The display 14 may be divided into one or more blocks to correspond to and display patterns of the partial or whole items provided by the user interface, such that a user may directly view corresponding items shown on the touch-screen apparatus 10. The patterns shown on the display 14 may be characters, numbers, symbols, designs or the combination thereof. The displaying types of the patterns may be, for example but not limited to, static or dynamic. In one embodiment, the detector 12 may be, for example but not limited to, one of capacitance-type, IR-type, resistance-type or ultrasound-type with a corresponding circuit. The display 14 may be, for example but not limited to, a liquid crystal display, plasma display, light-emitting diode or organic light-emitting diode. It is understood that the touch-screen apparatus 10 is equipped with a communication device (not shown in the figure) to transmit touch motion via wiring or wireless connection to be used as a control command for a corresponding item. In the case of wireless connection for the touch-screen apparatus 10 and the host 30, the touch-screen apparatus 10 is equipped with a power supply (not shown in the figure) for the detector 12 and the display 14. In the case of wiring connection for the touch-screen apparatus 10 and the host 30, such as a universal serial bus for the host 30 (or the image-capturing equipment 20), the host 30 may be supplied with power from the pins of the universal serial bus. Alternatively, the touch-screen apparatus 10 may be directly integrated into the image-capturing equipment 20.

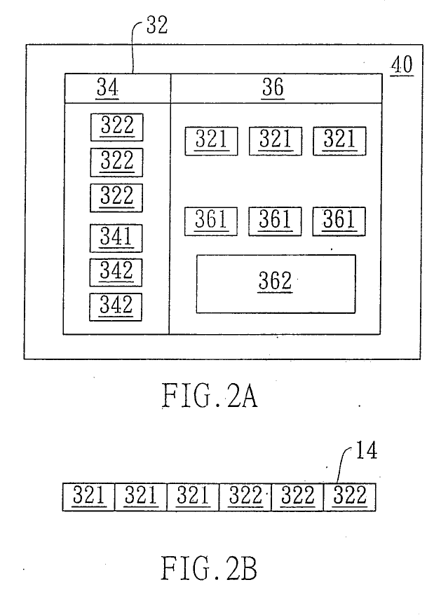

FIG. 2A is a schematic diagram illustrating the display user interface of a display according to one embodiment. FIG. 2B is a schematic diagram illustrating the display on the touch-screen apparatus according to one embodiment. Referring to FIG. 2A, the host is electrically coupled to the image-capturing equipment, the input device, the display 40 and the touch-screen apparatus, and executes the user interface 32. Generally, a user may utilize a keyboard or a mouse to select via the user interface 32. In the embodiment, in the user interface 32 illustrated on the display 40, a current interface is displayed and may include a function form 36 and a setting form 34 relevant to the operation of the image-capturing equipment. The function form 36 may include a plurality of items corresponding to the functions of the image-capturing equipment. The functions of the image-capturing equipment are ones relevant to hardware operation, such as prescan or overview. The items of the function form 36 may be displayed as button items 321 and 361 or a list 362. In the embodiment, the button items 321 may be correspondingly displayed on the display 14, as illustrated in FIG. 2B. Next, the setting form 34 may include a plurality of items corresponding to the settings of the image-capturing equipment. The settings of the image-capturing equipment are relevant to an objective sample, such as the source setting or size of the objective sample. The items of the setting form 34 may be displayed as button items 322, vertical scroll bar 341 or text box 342. For example, the button items 322 may be correspondingly displayed on the display 14 of the touch-screen apparatus, as illustrated in FIG. 2B.

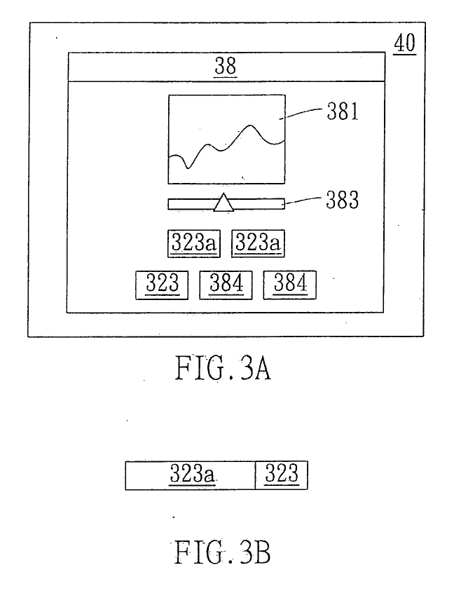

It is appreciated that the items correspondingly displayed on the touch-screen apparatus are not limited to the button types. They may be numerals associated with the different items on the user interface. Referring to FIG. 3A and FIG. 3B, another form 38 of the user interface is displayed on the display 40 after the process of FIG. 2A is completed, as illustrated in FIG. 3A. The form 38 includes a plurality of parameter settings relevant to the capture of images. Such parameter settings relevant to the capture of images are ones to be adjusted to the characteristics of a target object, such as image correction or gray-level adjustment. The items may be displayed as other types, such as the item of slider 383, picture display item 381, text box 323a, button items 323 and 384. In the embodiment, the text box 323a and the button item 323 may be correspondingly displayed on the display 14 of the touch-screen apparatus, as illustrated in FIG. 3B. These items displayed on the display 14 may be coordinated with various touching, such as drag-and-drop, so as to correspond to various items of the user interface.

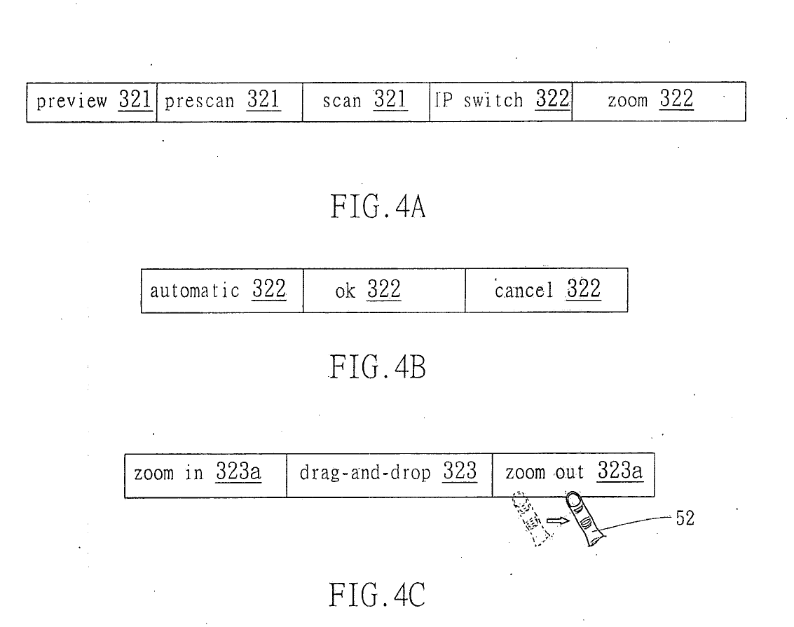

FIGS. 4A, 4B and 4C are the schematic diagrams illustrating the touch-screen apparatus in combination with various items in accordance with the embodiments of the present invention. Referring to FIG. 4A, the items illustrated on the touch-screen apparatus correspond to one or more current forms of the user interface. The user may input control commands through click on the touch-screen apparatus, and the detector of the touch-screen apparatus may correspondingly detect the click action at the moment. That is, the detector of the touch-screen apparatus enables detecting the click action but disables acting on other actions, such as double click or drag-and-drop. The detection of the click action from the touch-screen apparatus is transferred to the image-capturing equipment to be used as a control command for the corresponding item of the user interface. Referring to FIG. 4B, the detection of the touch-screen apparatus corresponds to the items of a current form displayed on the user interface. The user may click or double click on the touch-screen apparatus to input the control commands. In the embodiment, the detector may enable detection of the click on the block of a “self adjustment” item 322 on the touch-screen apparatus. However, the detector of the touch-screen apparatus enables only detection of double click but disables detection of the drag-and-drop on the blocks of an “OK” item 322 and a “Cancel” item 322. Referring to FIG. 4C, the detector enables detection of the click on a “drag-and-drop” item 323 first and then detection of the drag-and-drop on a “zoom in” item 323a or the “zoom out” item 323a of the touch-screen apparatus. Thus, the user may adjust the numeral items and the scales of a target object on the user interface through the drag-and-drop by a finger 52 on the “zoom in” item 323a and the “zoom out” item 323a.

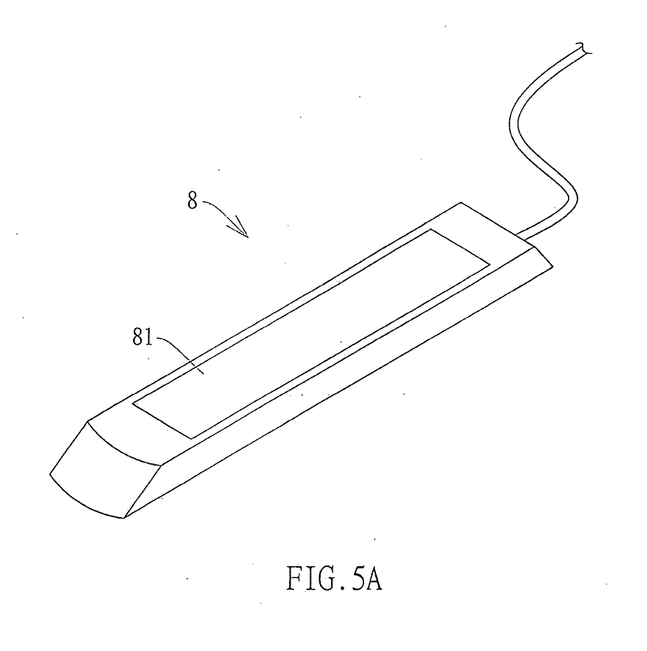

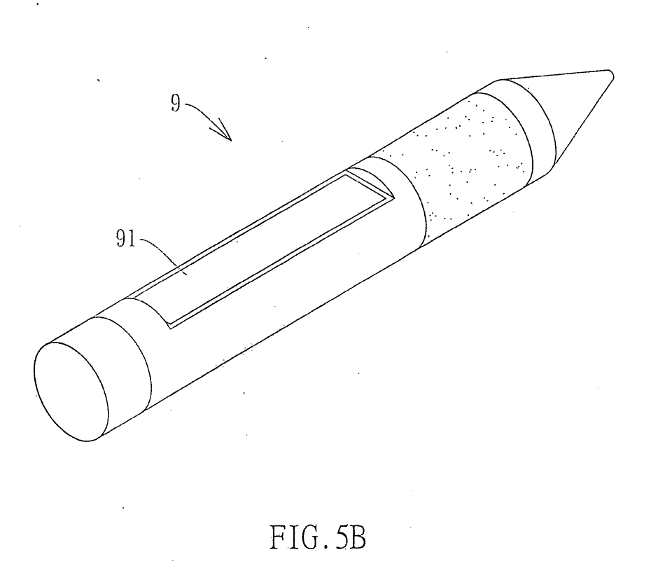

FIG. 5A and FIG. 5B are schematic diagrams illustrating the touch-screen apparatus. The touch-screen apparatuses 8 and 9 are electrically coupled with the host via wire or wireless connection. Moreover, the touch-screen apparatuses 8 and 9 are in bar shape configuration 81 and 91 and deposited on any light and compact apparatus. However, the shape of the touch-screen apparatus is not limited to one aforementioned. It may be in circle, array or other suitable shape. Accordingly, the touch-screen apparatus of the present invention may display and detect the buttons and the function thereof with the changing of the user interface. The user intuitively bi-directionally operates with her or his fingers on the touch-screen apparatus. Moreover, it is convenient for the user to take the small-size touch-screen apparatus. Thus, the present invention provides the touch-screen apparatus convenient for the user to take, easy for operation and friendly for display.

Although the present invention has been explained in relation to its preferred embodiment, it is to be understood that other modifications and variation can be made without departing the spirit and scope of the invention as hereafter claimed.

What is claimed is:

1. A touch-screen apparatus coupled with a user interface of an image-capturing equipment, the touch-screen apparatus comprising:
a detector detecting a touch motion; and
a display, wherein when the user interface of the image-capturing equipment provides a plurality of items relevant to the image-capturing equipment, and the display displays a plurality of patterns corresponding to the portion of items, the detector detects the touch motion on any of the patterns and transmits the touch motion to the user interface of the image-capturing equipment to be a control command for the corresponding item on the user interface.

2. A touch-screen apparatus according to claim 1, wherein the display is a liquid crystal display, a plasma display, a light-emitting display or an organic light-emitting display.

3. A touch-screen apparatus according to claim 1, wherein the detector is a capacitance type, an infra-red type, a resistance type or an ultrasound type detector with a circuit thereof.

4. A touch-screen apparatus according to claim 1, further comprising a communication device coupled with the user interface of the image-capturing equipment through wiring connection.

5. A touch-screen apparatus according to claim 1, further comprising a communication device coupled with the user interface of the image-capturing equipment via wireless connection.

6. A touch-screen apparatus according to claim 5, further comprising a power supply for the detector, the display and the communication device.

7. A touch-screen apparatus according to claim 1, wherein the detector detects the touch motion comprising single point touch, multi-point touch, one-finger sliding, fingers sliding, click or double clicks.

8. An image-capturing system, comprising an image-capturing equipment, a host, a touch-screen apparatus electrically coupled with each another, the image-capturing system comprising:
a user interface, controlled by the host to communicate with the image-capturing equipment and the touch-screen apparatus wherein the user interface provides a plurality of items relevant to the image-capturing equipment, and the touch-screen apparatus comprises:
a detector detecting a touch motion; and
a display, wherein when the user interface of the image-capturing equipment provides a plurality of items relevant to the image-capturing equipment, and the display displays a plurality of patterns corresponding to the portion of items, and the detector detects the touch motion on any of the patterns and transmits the touch motion to the user interface of the image-capturing equipment to be a control command for the corresponding item on the user interface.

9. An image-capturing system according to claim 8, wherein the display is a liquid crystal display, a plasma display, a light-emitting display or an organic light-emitting display.

10. An image-capturing system according to claim 8, wherein the detector is a capacitance type, an infra-red type, a resistance type or an ultrasound type detector with a circuit thereof.

11. An image-capturing system according to claim 8, wherein the host is a processor set in the image-capturing equipment.

12. An image-capturing system according to claim 8, wherein the host is a desktop or a laptop.

13. An image-capturing system according to claim 8, wherein the touch-screen apparatus comprises a communication device coupled with the host through wiring connection.

14. An image-capturing system according to claim 8, wherein the touch-screen apparatus comprises a communication device coupled with the host via wireless connection.

15. An image-capturing system according to claim 8, wherein the touch-screen apparatus is set on the image-capturing equipment.

16. An image-capturing system according to claim 8, wherein the image-capturing equipment is an image scanner or a multi function printer or fax machine.
